(19) United States
(12) Patent Application Publication
(10) Pub. No.: US 2012/0161033 A1
(43) Pub. Date: Jun. 28, 2012

(54) MICROORGANISM DETECTION APPARATUS

(75) Inventors: Joonhyung KWON, Incheon (KR); Hee Yuel ROH, Suwon-si (KR); Du Seop YOON, Seongnam-si (KR); Soo Hyun KIM, Daejeon (KR); Won Sik KWON, Jeonju-si (KR); Sung Yoon RYU, Daejeon (KR); Hyub LEE, Daejeon (KR)

(73) Assignees: KOREA ADVANCED INSTITUTE OF SCIENCE AND TECHNOLOGY, Yuseong-gu (KR); SAMSUNG ELECTRONICS CO., LTD., Suwon-si (KR)

(21) Appl. No.: 13/315,765

(22) Filed: Dec. 9, 2011

(30) Foreign Application Priority Data
Dec. 23, 2010 (KR) 10-2010-0133003

(51) Int. Cl. G01N 21/64

(52) U.S. Cl. 250/458.1

(57) ABSTRACT

A microorganism detection apparatus including a light source unit to irradiate light, a mirror chamber including a light inlet port and a light outlet port, through which the light is introduced and discharged, respectively an inlet port and an outlet port, through which particles are introduced and discharged, respectively, so that light emitted from the particles (emitted particle light) is generated by the light, and an opening, through which the emitted particle light is discharged outside. The mirror chamber has an oval longitudinal section, and is provided at an inside thereof with a mirror. A condensing optical system is disposed in front of the opening outside the opening to condense the emitted particle light discharged through the opening. Condensing efficiency of the fluorescent light condensing optical system is maximized.

### CROSS-REFERENCE TO RELATED APPLICATIONS

This application claims the benefit of Korean Patent Application No. 2010-0133003, filed on Dec. 23, 2010 in the Korean Intellectual Property Office, the disclosure of which is incorporated herein by reference.

### BACKGROUND

1. Field

Embodiments of the present invention relate to a microorganism detection apparatus to optically detect microorganisms floating in air.

2. Description of the Related Art

In recent years, interest in a clean and safe atmosphere has become increasingly high. Also, contaminants have increased as the result of industrial development, and new varieties of germs and harmful microorganisms have evolved. In particular, microorganisms, such as bacteria, viruses and mold, in air are known to be a major cause of various fatal diseases including atopic diseases, bronchial diseases and pulmonary diseases.

A conventional microorganism detection method includes collecting microorganisms from air, cultivating the collected microorganisms on a culture medium and detecting the microorganisms based on the number and kind of cultivated microorganism groups.

However, the above method takes several hours to several days to cultivate the collected microorganisms. Also, some bacteria may not be cultivated using normal methods. For this reason, diagnosable microorganisms are limited to cultivable microorganisms.

Therefore, there is a need to develop easier and faster microorganism detection technology for the general public to easily monitor an atmospheric state in real time.

### SUMMARY

It is an aspect of the present invention to provide a microorganism detection apparatus, including a mirror chamber to reflect light emitted from particles to which light is irradiated and discharge the reflected light and a condensing optical system to condense the light discharged from the mirror chamber, to detect microorganisms based on fluorescent light emitted from the particles.

Additional aspects of the invention will be set forth in part in the description which follows and, in part, will be obvious from the description, or may be learned by practice of the invention.

In accordance with one aspect of the present invention, a microorganism detection apparatus includes a light source unit to irradiate light, a mirror chamber including a light inlet port and a light outlet port, through which the light is introduced and discharged, an inlet port and an outlet port, through which particles are introduced and discharged so that light emitted from the particles (emitted particle light) is generated by the light, and an opening, through which the emitted particle light is discharged outside, the mirror chamber having an oval longitudinal section, the mirror chamber being provided at an inside thereof with a mirror, and a condensing optical system disposed in front of the opening outside the opening to condense the emitted particle light discharged through the opening.

The condensing optical system may include a collimating lens to convert the emitted particle light into collimated light, a light separator to separate fluorescent light from the light converted into the collimated light by the collimating lens, and a light receiver to receive the fluorescent light separated by the light separator.

The opening may be provided at one side of the mirror chamber so that a first focal point and a second focal point are located in the oval longitudinal section of the mirror chamber.

The mirror chamber may be configured so that light is emitted from the particles at the first focal point.

The opening may be provided at a side of the mirror chamber adjacent to the second focal point.

The opening may be provided at a side of the mirror chamber adjacent to the first focal point.

Eccentricity of the oval longitudinal section of the mirror chamber may be adjusted and the position of the opening may be adjusted based on the adjusted eccentricity and the numerical aperture of the condensing optical system to increase condensing efficiency of the condensing optical system.

The position of the opening may be adjusted so that an angle between a focal point adjacent to the opening, i.e., one of the first and second focal points, and the opening is equal to the numerical aperture of the condensing optical system.

The collimating lens may include a plurality of diverging lenses to diverge light or a plurality of converging lenses to converge light.

The collimating lens may include a first lens and a second lens spaced a predetermined distance from each other, the collimated light passing between the first lens and the second lens.

The light separator may be disposed between the first lens and the second lens.

The light separator may include a filter or a dichroic mirror.

The collimating lens may include a lens having a non-spherical surface formed at one side or opposite sides thereof.

The inlet port, the outlet port, the light inlet port and the light outlet port may be disposed so that a path of the particles introduced into the mirror chamber intersects light irradiated to the particles.

In accordance with another aspect of the present invention, a microorganism detection apparatus includes a mirror chamber having an oval longitudinal section, the mirror chamber being provided at an inside thereof with a mirror, an introduction unit through which particles are introduced into the mirror chamber, a light source unit to irradiate the particles introduced into the mirror chamber to generate light emitted from the particles (emitted particle light), an opening provided at the mirror chamber to allow the emitted particle light to be discharged out of the mirror chamber therethrough, and a condensing optical system disposed in front of the opening outside the opening to condense the emitted particle light discharged out of the mirror chamber through the opening.

The condensing optical system may include a collimating lens to convert the emitted particle light into collimated light, a light separator to separate fluorescent light from the emitted particle light converted into the collimated light by the collimating lens, and a light receiver to receive the fluorescent light separated by the light separator.

The opening may be provided at one side of the mirror chamber so that a first focal point and a second focal point are located in the oval longitudinal section of the mirror chamber.

The mirror chamber may be configured so that light is emitted from the particles at the first focal point.

The opening may be provided at a side of the mirror chamber adjacent to the second focal point.

The opening may be provided at a side of the mirror chamber adjacent to the first focal point.

The light source unit may include a light emitting optical element and a converging optical system to converge light emitted from the optical element.

The optical element may include a laser diode (LD) or a light emitting diode (LED).

Eccentricity of the oval longitudinal section of the mirror chamber may be adjusted and the position of the opening may be adjusted based on the adjusted eccentricity to increase condensing efficiency of the condensing optical system.

The position of the opening may be adjusted so that an angle between a focal point adjacent to the opening, i.e., one of the first and second focal points, and the opening is equal to the numerical aperture of the condensing optical system.

In accordance with another aspect of the present invention, a microorganism detection apparatus includes a mirror chamber having an oval longitudinal section, the mirror chamber being provided with an opening, an introduction unit through which particles are introduced into the mirror chamber, and a light source unit to irradiate the particles introduced into the mirror chamber so that light is emitted from the particles, wherein the opening is provided at one side of the mirror chamber so that a first focal point and a second focal point are located in the oval longitudinal section of the mirror chamber, and the mirror chamber reflects the light emitted from the particles (emitted particle light) and discharges the reflected light to the opening.

The mirror chamber may be configured so that light is emitted from the particles at the first focal point.

The opening may be provided at a side of the mirror chamber adjacent to the second focal point.

The opening may be provided at a side of the mirror chamber adjacent to the first focal point.

In accordance with a further aspect of the present invention, a microorganism detection apparatus includes a mirror chamber having an oval longitudinal section, the mirror chamber being provided with an opening, an introduction unit through which particles are introduced into the mirror chamber, and a light source unit to irradiate the particles introduced through the introduction unit so that light is emitted from the particles, wherein the opening is provided at one side of the mirror chamber so that a first focal point and a second focal point are located in the oval longitudinal section of the mirror chamber, and the mirror chamber reflects the light emitted from the particles (emitted particle light) and discharges the reflected light to the opening, and a condensing optical system disposed in front of the opening outside the opening to condense the light discharged out of the mirror chamber through the opening.

The condensing optical system may include a collimating lens to convert the light discharged through the opening into collimated light, a light separator to separate fluorescent light from the light collimated by the collimating lens, and a light receiver to receive the fluorescent light separated by the light separator.

Eccentricity of the oval longitudinal section of the mirror chamber may be adjusted and the position of the opening may be adjusted based on the adjusted eccentricity to increase condensing efficiency of the condensing optical system.

The position of the opening may be adjusted so that an angle between a focal point adjacent to the opening, i.e., one of the first and second focal points, and the opening is equal to the numerical aperture of the condensing optical system.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 shows a microorganism detection apparatus according to an embodiment of the present invention;

FIG. 2 is a sectional view of the microorganism detection apparatus shown in FIG. 1;

FIG. 3 is a sectional view showing a first example of a mirror chamber shown in FIG. 1;

FIG. 4 is a view showing a state in which light reflected in the mirror chamber of FIG. 3 is condensed by a condensing optical system;

FIG. 5 is a sectional view showing a second example of the mirror chamber shown in FIG. 1;

FIG. 6 is a view showing a state in which light reflected in the mirror chamber of FIG. 5 is condensed to the condensing optical system;

FIG. 7A is a view showing a first example of a condensing optical system shown in FIG. 1;

FIG. 7B is a view showing a second example of the condensing optical system shown in FIG. 1

FIG. 8 is a conceptual view showing a relationship between eccentricity of a mirror chamber shown in FIG. 3 and the position of an opening of the mirror chamber; and

FIG. 9 is a graph showing change in condensing efficiency based on eccentricity of the mirror chamber.

### DETAILED DESCRIPTION

Reference will now be made in detail to the embodiments of the present invention, examples of which are illustrated in the accompanying drawings, wherein like reference numerals refer to like elements throughout.

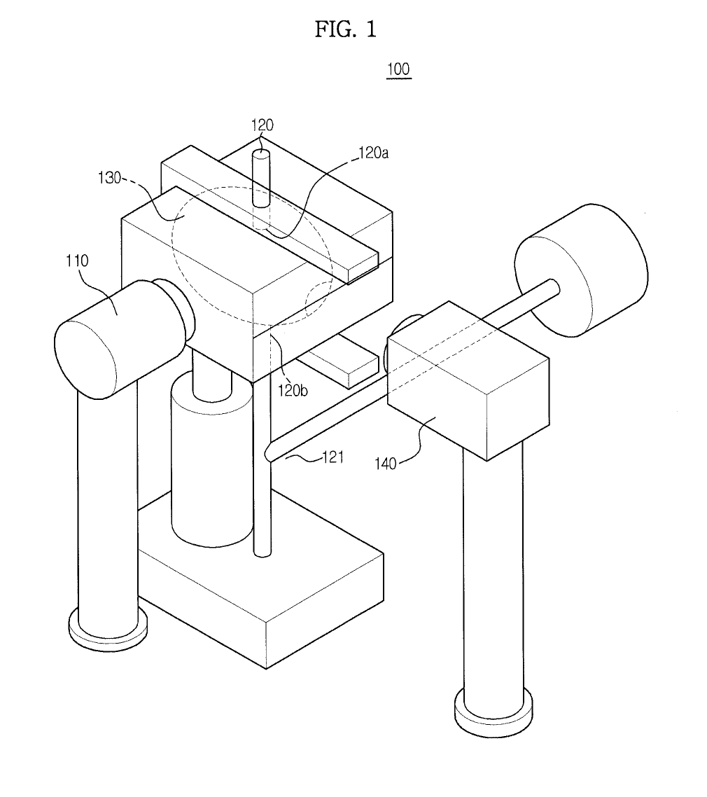

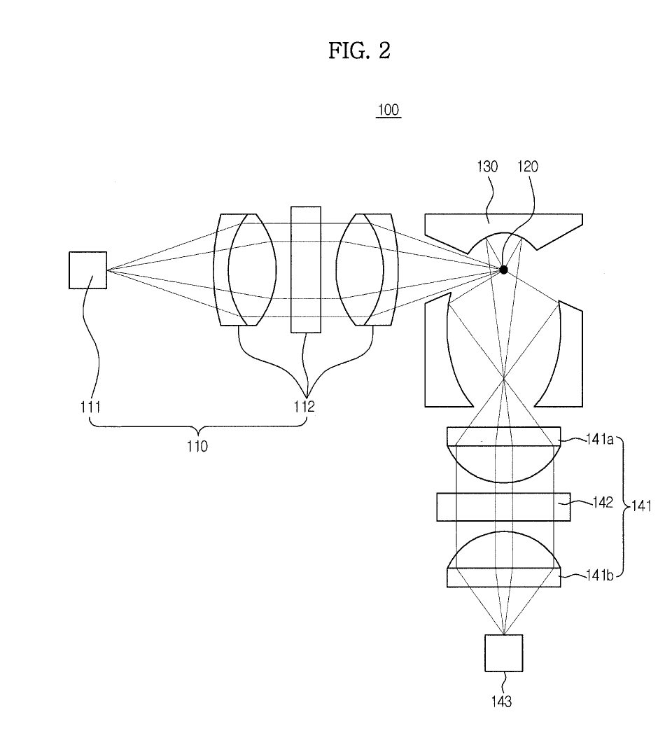

FIG. 1 shows a microorganism detection apparatus 100 according to an embodiment of the present invention, and FIG. 2 is a sectional view of the microorganism detection apparatus 100 shown in FIG. 1.

The microorganism detection apparatus 100 includes a light source unit 110, an introduction unit 120, a mirror chamber 130 and a condensing optical system 140.

The light source unit 110, which irradiates light to particles, includes a light emitting optical element 111 and a converging optical system 112 to converge light emitted from the optical element 111.

The optical element 111 may include a laser diode (LD) or a light emitting diode (LED).

In particular, in this embodiment, the optical element 111 emits light of an ultraviolet wavelength band to induce fluorescent light based upon binding with metabolites in microorganisms.

The converging optical system 112, including a plurality of lenses and a spectral filter, converges light emitted from the optical element 111 so that the light is irradiated into the mirror chamber 130.

The converging optical system 112 is designed to irradiate a light source exhibiting high optical density to particles. Specifically, a plurality of collimating lenses, one side or opposite sides of which are non-spherical, is used to minimize the size of a focal point of a light source.

In particular, in a case in which the optical element 111 is an LED, it may be necessary to precisely design the converging optical system 112. This is because an LED light source exhibits the behavior of a surface light source, not a point light source, and a light source exhibiting high optical density may be needed while stray light is excluded to the highest degree to emit fluorescent light from microorganisms.

The introduction unit 120 introduces environmental air or liquid particles (hereinafter, referred to as particles) in an aerosol phase into the microorganism detection apparatus 100 to sample the particles.

Specifically, the introduction unit 120 includes a nozzle through which the particles flow into the mirror chamber 130. Also, the introduction unit 120 is connected to a pump 121 to discharge the particles introduced into the mirror chamber 130 to the outside.

That is, one end of the introduction unit 120, which is a particle inlet, is connected to the mirror chamber 130 so that the introduced particles flow into the mirror chamber 130. Also, the other end of the introduction unit 120 is connected to the pump 121 so that the particles are discharged from the mirror chamber 130. Therefore, the introduction unit 120 may have a particle inlet port 120a, through which particles are introduced into the mirror chamber 130, and a particle outlet port 120b, through which particles are discharged from the mirror chamber 130.

The mirror chamber 130 is an optical chamber to detect microorganisms. The longitudinal section of the mirror chamber 130 is oval.

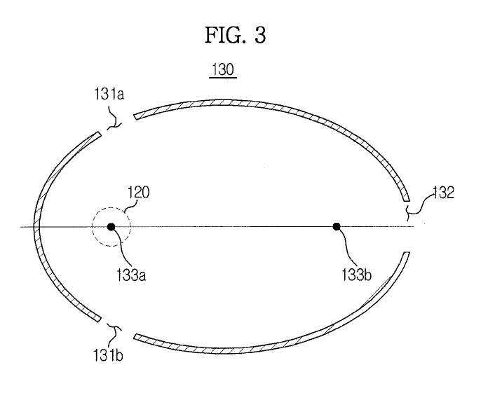

The mirror chamber 130 is connected to the introduction unit 120. As shown particularly in FIG. 3, the mirror chamber 130 has a light inlet port 131a, through which light emitted from the light source unit 110 is irradiated into the mirror chamber 130, and a light outlet port 131b.

The mirror chamber 130 reflects light emitted from particles and discharges the light through an opening 132. Specifically, light incident upon the mirror chamber 130 is irradiated to particles introduced into the mirror chamber 130 through the introduction unit 120 with the result that the particles emit light. The emitted light is reflected in the mirror chamber 130 and is discharged to the opening 132, which is formed at a predetermined position of the mirror chamber 130.

In particular, in this embodiment, the mirror chamber 130 is disposed so that an intersection point of light beams emitted from the particles and the light source unit 110 is located at one of two focal points of an oval. To this end, the inlet port 120a, the outlet port 120b, the light inlet port 131a and the light outlet port 131b are disposed so that particles introduced into the mirror chamber 130 and light irradiated to the particles intersect at one of the two focal points of the oval. That is, light is emitted from particles at one 133a of the two focal points of the oval, and the emitted light is reflected in the mirror chamber 130 and focused at the other focal point 133b.

Also, in this embodiment, parameters of the mirror chamber 130 may be adjusted to improve condensing efficiency of the condensing optical system 140. The parameters of the mirror chamber 130 include eccentricity and the position of the opening 132, related to the size of the oval, which is the longitudinal section of the mirror chamber 130. The position of the opening 132 may be adjusted at the mirror chamber 130 having appropriate eccentricity. The adjustment of the parameters of the mirror chamber 130 to maximize condensing efficiency will be described in detail below.

The condensing optical system 140 condenses light discharged through the opening 132 at the outside of the mirror chamber 130 and detects fluorescent light from the condensed light to determine whether microorganisms are present in the particles.

The condensing optical system 140, located in front of the opening 132, includes a collimating lens 141, a light separator 142 and a light receiver 143.

The collimating lens 141 may include a plurality of converging convex lenses or a combination of plural converging lenses and plural diverging concave lenses.

The collimating lens 141 collimates light discharged through the opening 132. That is, light passes through the diverging lenses or the converging lenses into collimated light or gentle diverged or converged light.

The light separator 142, including a filter or a dichroic mirror, isolates fluorescent light from light emitted from particles. Light emitted from particles contains fluorescent light formed by microorganisms, light scattered by micro particles and stray light. Fluorescent light has a wavelength of 450 to 550 nm, which is different from that of the scattered light or the stray light. In this embodiment, the light separator 142 separates fluorescent light from light emitted from particles using such a wavelength of fluorescent light.

The light separator 142 separates fluorescent light from light collimated by the collimating lens 141. Generally, transmission efficiency of a filter or a dichroic mirror varies depending upon the incidence angle of light. In this embodiment, the light separator 142 is located at a region upon which collimated light is incident to prevent reduction in transmission efficiency. As a result, the light separator 142 has a structure upon which light is incident perpendicularly.

After fluorescent light is separated by the light separator 142 while scattered light and stray light are blocked, the separated fluorescent light is incident upon the light receiver 143.

The light receiver 143, detecting the incident fluorescent light, includes a light receiving element, such as a photo diode (PD) or a photo multiplier tube (PMT). The light receiver 143 may transmit a signal to a signal processing apparatus via an amplifier circuit and a filter.

The light receiver 143 converts light into electricity. The light converts energy of photons absorbed into the light receiver 143 into a detectable form to measure intensity of the received fluorescent light. Also, the light receiver 143 may determine whether the measured intensity of the fluorescent light exceeds a predetermined critical value and, upon determining that the measured intensity of the fluorescent light exceeds the predetermined critical value, determines that microorganisms are present.

Also, a spectroscope may be mounted at the light receiver 143 to measure the wavelength of the received fluorescent light and to determine kinds of the microorganisms based on the measured wavelength.

A method of detecting microorganisms using the microorganism detection apparatus according to this embodiment will be described briefly. Particles containing microorganisms floating in air are introduced into the mirror chamber 130 through the introduction unit 120, including the nozzle. Light beams are irradiated to the introduced particles at a predetermined position, and the particles emit light including fluorescent light emitted from the microorganisms.

The emitted light is condensed by the condensing optical system 140 via a predetermined optical path. The condensed light is filtered by the light separator 142 with the result that only the fluorescent light emitted from the microorganisms is detected by the light receiver 143. Whether microorganisms are present in the particles and the kinds of the microorganisms may be determined based on the detected fluorescent light.

Using the microorganism detection apparatus according to this embodiment, microorganisms floating in air may be rapidly detected in real time.

Also, the microorganism detection apparatus according to this embodiment may be manufactured to have a relatively small size at low cost. Consequently, the microorganism detection apparatus according to this embodiment may be widely used in a variety of industries. For example, the microorganism detection apparatus according to this embodiment may be integrated into home appliances so that the public may easily monitor harmful microorganisms indoors.

Meanwhile, as previously described, the condensing optical system 140 is provided to condense fluorescent light reflected in the mirror chamber. As the numerical aperture of light exiting the mirror chamber increases, the size of the collimating lens of the condensing optical system is increased. As a result, condensing loss may occur or miniaturization of the microorganism detection apparatus may not be achieved due to the increase in size of the collimating lens.

The reflectance of the mirror chamber may be increased to improve condensing efficiency. In actuality, however, it may be difficult to manufacture a mirror chamber having a reflectance of 95% or more.

Hereinafter, a microorganism detection apparatus according to an embodiment of the present invention that maximizes condensing efficiency without increasing the size of the collimating lens using a mirror chamber having a possible reflectance will be described.

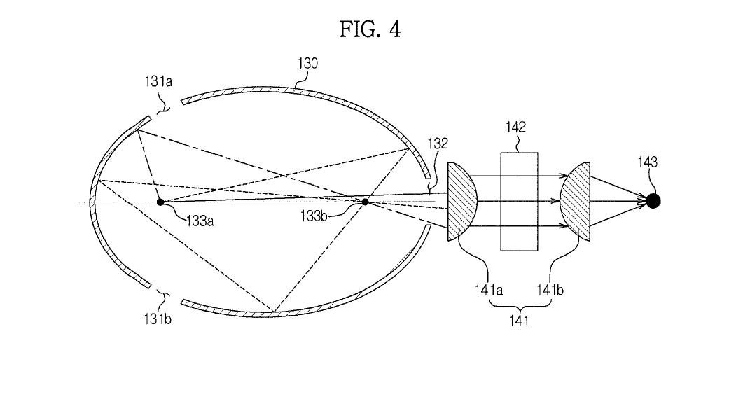

FIG. 3 is a sectional view showing a first example of the mirror chamber shown in FIG. 1, and FIG. 4 is a view showing a state in which light reflected in the mirror chamber of FIG. 3 is condensed to the condensing optical system.

Referring to FIG. 3, the mirror chamber 130 includes light inlet port 131a and light outlet port 131b, through which light is introduced and discharged, and an opening 132, through which light emitted from particles is discharged to the condensing optical system 140.

The opening 132 is formed by cutting a portion of the mirror chamber 130 perpendicularly to the major axis of the mirror chamber 130. The opening 132 is an open optical path, formed at one side of the mirror chamber 130, through which light is discharged to the condensing optical system.

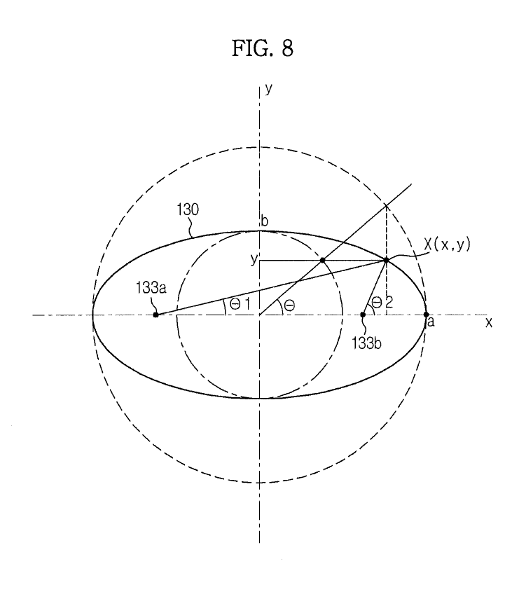

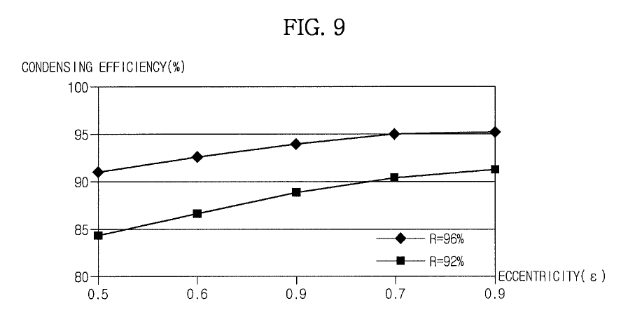

The size of the opening 132 is based on the position of the opening 132, which is a distance from an intersection point of the perpendicularly cut plane and the major axis of the opening 132 to the center of the mirror chamber 130. The position of the opening 132 is a parameter influencing condensing efficiency of the microorganism detection apparatus. A method of appropriately selecting the position of the opening 132 to maximize condensing efficiency will be described below with reference to FIGS. 8 and 9.

In this embodiment, the position of the opening 132 is decided so that a first focal point 133a and a second focal point 133b of an oval are included in the longitudinal section of the mirror chamber 130. Specifically, the opening 132 is located outside the second focal point 133b so that the first focal point 133a and the second focal point 133b are included in the longitudinal section of the mirror chamber 130.

In this embodiment, the mirror chamber 130 is connected to the introduction unit 120, through which particles are introduced. The mirror chamber 130 is positioned so that an intersection point at which the introduced particles meet light irradiated from the light source unit becomes the first focal point 133a. Specifically, light is irradiated to the introduced particles, and light is emitted from the particles to which the light has been irradiated at the first focal point 133a. That is, light is emitted from the particles at the first focal point 133a.

The optical path of the light emitted at the first focal point 133a is shown in FIG. 4.

Referring to FIG. 4, the light emitted at the first focal point 133a is reflected in the mirror chamber 130 and is then discharged to the opening 132.

The light emitted at the first focal point 133a is directly discharged (solid line) to the opening 132. Alternatively, the light is reflected once (dashed dot line) or three times (dotted line) and is then discharged to the opening 132 via the second focal point 133b. That is, the light emitted at the first focal point 133a is discharged without passing through the second focal point 133b from the first focal point 133a or is discharged via the second focal point 133b after being reflected from a wall of the mirror chamber 130.

The light emitted from the particles is isotropic; however, the light passes through the first focal point 133a and the second focal point 133b of the mirror chamber 130 with the result that the light is converged to a relatively small angle and discharged. This means that the numerical aperture of the discharged light is small and that the size and aberration of the collimating lens of the condensing optical system may be reduced. Consequently, the microorganism detection apparatus may be miniaturized and condensing efficiency may be maximized.

The light discharged from the mirror chamber 130 is collimated by the collimating lens 141. The collimating lens 141 includes a plurality of lenses 141a and 141b between which collimated light is induced. The induced collimated light passes through the light separator 142, which detects fluorescent light from the collimated light. The detected fluorescent light is received by the light receiver 143.

That is, the light separator 142 is disposed between the collimating lenses 141a and 141b, and the light receiver 143 is disposed at the rear of the collimating lens 141 and the light separator 142 to receive the collimated fluorescent light.

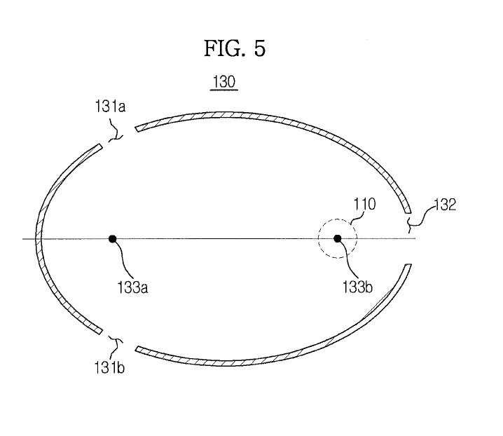

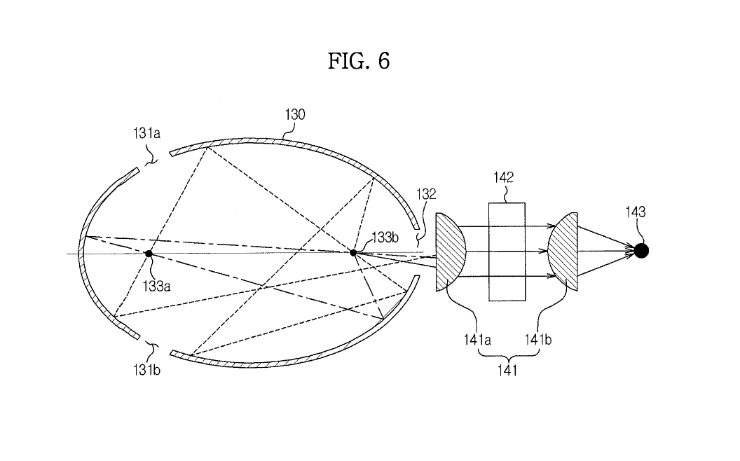

FIG. 5 is a sectional view showing a second example of the mirror chamber shown in FIG. 1, and FIG. 6 is a view showing a state in which light reflected in the mirror chamber of FIG. 5 is condensed by the condensing optical system.

Referring to FIG. 5, the opening 132 is positioned outside the second focal point 133b so that the first focal point 133a and the second focal point 133b of the oval are included in the longitudinal section of the mirror chamber 130.

Also, a position at which light emitted from the light source unit 110 is irradiated to particles becomes the second focal point 133b. That is, light is emitted from the particles at the second focal point 133b.

The optical path of the light emitted at the second focal point 133b is shown in FIG. 6. The light emitted at the second focal point 133b may be directly discharged (solid line) to the opening 132. Alternatively, the light may be reflected several times (dashed dot line or dotted line) and then discharged to the opening 132 via the first focal point 133a and the second focal point 133b.

That is, in the optical path of the mirror chamber according to this embodiment, the light discharged from the second focal point 133b is discharged to the opening 132. Light discharged from a focal point has the same numerical aperture, and therefore, collimated light is uniformly formed by the collimating lens 141, thereby achieving high condensing efficiency.

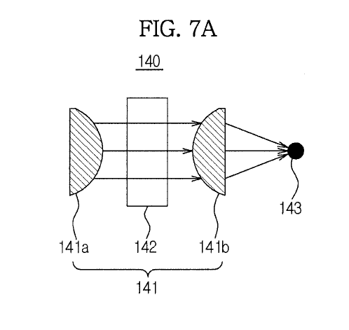

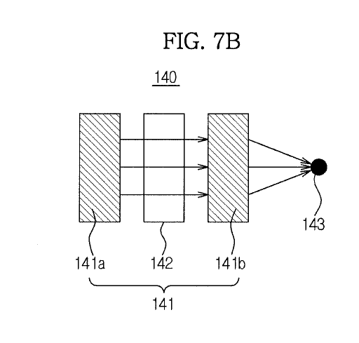

FIG. 7A is a view showing a first example of the condensing optical system shown in FIG. 1.

Referring to FIG. 7A, light passing through the condensing optical system is converted into collimated light between the collimating lenses 141. The collimated light is incident upon the light separator 142. The light, passing through the light separator 142, converges on the light receiver 143.

Hereinafter, the collimating lens 141, the light separator 142 and the light receiver 143 constituting the condensing optical system 140 will be described in detail.

The collimating lens 141 of FIG. 7A includes a first converging lens 141a and a second converging lens 141b. At least one side of each of the converging lenses is non-spherical to generate excellent collimated light.

The first lens 141a and the second lens 141b are disposed so that the corresponding sides of the first lens 141a and the second lens 141b face each other. Incident light is converted into collimated light while passing through the first lens 141a and the second lens 141b disposed as described above.

Specifically, the first lens 141a and the second lens 141b, having the same size as shown in FIG. 7A, are disposed so that the convex surfaces of the first lens 141a and the second lens 141b face each other. However, collimating lenses having the same size and disposed so that the corresponding sides of the collimating lenses face each other although the collimating lenses are disposed in a different manner than in FIG. 7A are included within the scope of the present invention. That is, collimating lenses disposed so that the non-spherical surfaces of the collimating lenses face each other while the convex surfaces of the collimating lenses face outward unlike FIG. 7A are included within the scope of the present invention.

The first lens 141a and the second lens 141b, which are disposed symmetrically, may be formed to be movable in an optical axial direction so as to correct aberration caused due to wavelength fluctuation based on temperature and oscillation wavelength deviation of the light source unit. That is, the first lens 141a and the second lens 141b are spaced a predetermined distance from each other to correct such aberration.

The light separator 142 removes scattered light and stray light from the incident light using collimated light having the same incident angle to separate fluorescent light induced by a microorganism. The light separator 142 is disposed between the first lens 141a and the second lens 141b to separate fluorescent light.

Meanwhile, instead of a plurality of converging lenses, the collimating lens 141 may include a plurality of diverging lenses or non-spherical lenses, which will be described with reference to FIGS. 7B.

FIG. 7B is a view showing a second example of the condensing optical system shown in FIG. 1.

Referring to FIG. 7B, the first lens 141a and the second lens 141b constituting the collimating lens 141 each have non-spherical surfaces formed at opposite sides thereof.

Light is collimated by the first lens 141a and the second lens 141b so long as the first lens 141a and the second lens 141b have the same size.

Also, in this embodiment, the first lens 141a and the second lens 141b may be diffraction lenses each having circular diffraction about an optical axis, i.e., hologram optical elements. The hologram optical elements diverge and converge light emitted from a light source. Also, the hologram optical elements each have a short optical path length. Consequently, the condensing optical system may be miniaturized using the hologram optical elements.

In the above description, the respective components of the microorganism detection apparatus have been explained. The microorganism detection apparatus detects fluorescent light induced by microorganisms to determine whether floating microorganisms are present in air. The efficiency of the microorganism detection apparatus is improved if light emitted from particles is condensed without loss.

Hereinafter, a method of adjusting parameters of the mirror chamber to improve condensing efficiency will be described with reference to FIGS. 8 and 9.

FIG. 8 shows a relationship between eccentricity of the longitudinal section of the mirror chamber shown in FIG. 3 and the position of an opening of the mirror chamber, and FIG. 9 is a graph showing change in condensing efficiency based on eccentricity of the longitudinal section of the mirror chamber.

In this embodiment, eccentricity of the longitudinal section of the mirror chamber is adjusted, and the position of the opening is adjusted based on the adjusted eccentricity, thereby maximizing condensing efficiency.

FIG. 8 is a sectional view of the mirror chamber 130 projected on an xy plane showing a relationship between a position X of the opening formed by cutting a portion of the mirror chamber 130 perpendicularly to the major axis of the mirror chamber 130 to discharge light and the lengths of the major axis 2a and the minor axis 2b.

First, the position X of the opening may be expressed using a circle (dotted line) having the major axis as a diameter and a circle (dashed dot line) having the minor axis as a diameter as follows.

X=(x, y) Expression 1

x=a cos θ, y=b sin θ

It may be seen that the position X of the opening is related to the lengths of the major axis 2a and the minor axis 2b. Hereinafter, a method of setting the position of the opening based on eccentricity of the longitudinal section of the mirror chamber will be described.

Referring to FIG. 9, it may be seen that condensing efficiency increases as eccentricity increases when the reflectance of the mirror chamber is 96% and 92%.

Meanwhile, eccentricity is a degree to which a quadratic curve deviates from the form of a circle. For an oval having higher eccentricity, the length of the minor axis is much less than that of the major axis. In this case, therefore, the mirror chamber may not be miniaturized.

For this reason, it may be necessary to decide eccentricity appropriate to miniaturize the mirror chamber and to set the position X of the opening to maximize condensing efficiency based on the decided eccentricity.

To this end, first, the position X of the opening is estimated based on angles θ₁ and θ₂ between two focal points 133a and 133b of the oval and the opening as shown in FIG. 8, The angles θ₁ and θ₂ are expressed as represented by Equation 2.

$$θ = {tan}^{-} ( \frac{b sin θ}{a cos θ + c} ) \\ θ = {tan}^{-} ( \frac{b sin θ}{a cos θ - c} ) \qquad Equation 2$$

In Equation 2, c indicates the distance from the center of the oval to the focal points 133a and 133b.

In the mirror chamber, light is emitted at the first focal point 133a or the second focal point 133b and is discharged to the opening. When light emitted at the first focal point 133a or the second focal point 133b is discharged to the opening without loss and is condensed by the condensing optical system, condensing efficiency is maximized. Consequently, the position X of the opening is adjusted in consideration of the numerical aperture of the condensing optical system.

The angle θ0₁ between the first focal point 133a and the opening is greater than the angle θ₂ between the second focal point 133b and the opening. Consequently, θ₂ satisfies Equation 3.

$$( θ 2 = \frac{b sin θ}{a cos θ - c} ) \leq N A \qquad Equation 3$$

That is, θ₂ may be approximated by

$$\frac{b sin θ}{a cos θ - c} .$$

The valve of θ₂ may be less than or equal to the numerical aperture (NA) of the condensing optical system. When θ₂ is equal to the numerical aperture (NA), condensing efficiency is maximized.

θ may be calculated using θ₂ set as described above as follows. First, θ₂ may be expressed as represented by Equation 4 using a fact that sin θ is approximately θ and cos θ is approximately 1 when 8 may be is 30 degrees or less. Also, θ may be calculated as represented by Equation 5 using the approximated θ₂.

$$\begin{matrix}{θ}_{2} = ( \frac{b sin θ}{a cos θ - c} ) \approx ( \frac{b θ}{a - c} ) = N A & Equation 4 \\ c = \sqrt{{a}^{2} - {b}^{2}} = ɛ a , \\ c = \sqrt{{a}^{2} - {b}^{2}} = ɛ a \\ θ = \sqrt{\frac{1 - ɛ}{1 + ɛ}} \cdot N A & Equation 5\end{matrix}$$

Referring to Equation 5, the distance c from the center of the oval to the focal point and minor axis b of the oval may be expressed using eccentricity ε of the oval and the major axis a of the oval. These are substituted into Equation 4 to calculate θ. Consequently, θ may be expressed using eccentricity E of the oval and the numerical aperture (NA) of the condensing optical system as represented by Equation 5.

The calculated θ may be substituted into Equation 1 to calculate the position X of the opening.

That is, eccentricity of the longitudinal section of the mirror chamber is appropriately set, and the position of the opening is set in consideration of the set eccentricity and the numerical aperture of the condensing optical system. Condensing efficiency is maximized while the microorganism detection apparatus is miniaturized by adjusting the parameters of the mirror chamber through the above process.

As is apparent from the above description, the microorganism detection apparatus is configured so that light emitted from particles is reflected, the reflected light is discharged to a predetermined opening, and the discharged light is condensed by a condensing optical system, thereby maximizing condensing efficiency of the fluorescent light condensing optical system.

Also, an optical method is used instead of the conventional method of collecting and cultivating microorganisms, thereby detecting microorganisms floating in air in real time.

Also, the microorganism detection apparatus is manufactured to have a relatively small size at low costs. The microorganism detection apparatus may be integrated into home appliances so that the public may easily monitor harmful microorganisms indoors.

Also, the microorganism detection apparatus may be used in pharmaceutical, health and food industry to monitor environmental microorganisms in real time. Consequently, the microorganism detection apparatus may be helpful in public health, quality control and regulation.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A microorganism detection apparatus comprising:
a light source unit to irradiate light;
a mirror chamber having a light inlet port and a light outlet port, through which the light is introduced and discharged, a particle inlet port and a particle outlet port, through which particles are introduced and discharged so that light emitted from the particles is generated by the light, an opening, through which the emitted particle light is discharged outside, the mirror chamber, an oval longitudinal section, and a mirror at an inside thereof; and
a condensing optical system disposed at an outside of the opening to condense the emitted particle light discharged through the opening.

2. The microorganism detection apparatus according to claim 1, wherein the condensing optical system comprises:
a collimating lens to convert the emitted particle light into collimated light;
a light separator to separate fluorescent light from the light converted into the collimated light by the collimating lens; and
a light receiver to receive the fluorescent light separated by the light separator.

3. The microorganism detection apparatus according to claim 1, wherein the opening is provided at one side of the mirror chamber so that a first focal point and a second focal point are located in the oval longitudinal section of the mirror chamber.

4. The microorganism detection apparatus according to claim 3, wherein the mirror chamber is configured so that light is emitted from the particles at the first focal point.

5. The microorganism detection apparatus according to claim 4, wherein the opening is provided at a side of the mirror chamber adjacent to the second focal point.

6. The microorganism detection apparatus according to claim 4, wherein the opening is provided at a side of the mirror chamber adjacent to the first focal point.

7. The microorganism detection apparatus according to claim 3, wherein eccentricity of the oval longitudinal section of the mirror chamber is adjusted, and a position of the opening is adjusted based on the adjusted eccentricity and a numerical aperture of the condensing optical system, to increase condensing efficiency of the condensing optical system.

8. The microorganism detection apparatus according to claim 7, wherein the position of the opening is adjusted so that an angle between one of the first and second focal points, and the opening is equal to the numerical aperture of the condensing optical system.

9. The microorganism detection apparatus according to claim 2, wherein the collimating lens comprises a plurality of diverging lenses to diverge light or a plurality of converging lenses to converge light.

10. The microorganism detection apparatus according to claim 2, wherein the collimating lens comprises a first lens and a second lens spaced a predetermined distance from each other, the collimated light passing between the first lens and the second lens.

11. The microorganism detection apparatus according to claim 10, wherein the light separator is disposed between the first lens and the second lens.

12. The microorganism detection apparatus according to claim 2, wherein the light separator comprises a filter or a dichroic mirror.

13. The microorganism detection apparatus according to claim 2, wherein the collimating lens comprises a lens having a non-spherical surface formed at one side or opposite sides thereof.

14. The microorganism detection apparatus according to claim 1, wherein the particle inlet port, the particle outlet port, the light inlet port and the light outlet port are disposed so that a path of the particles introduced into the mirror chamber intersects light irradiated to the particles.

15. A microorganism detection apparatus comprising:
a mirror chamber having an oval longitudinal section, the mirror chamber being provided at an inside thereof with a mirror;
an introduction unit through which particles are introduced into the mirror chamber;
a light source unit to irradiate the particles introduced into the mirror chamber to generate light emitted from the particles;
an opening provided at the mirror chamber to allow the emitted particle light to be discharged out of the mirror chamber; and
a condensing optical system disposed at an outside of the opening to condense the emitted particle light discharged out of the mirror chamber through the opening.

16. The microorganism detection apparatus according to claim 15, wherein the condensing optical system comprises:
a collimating lens to convert the emitted particle light into collimated light;
a light separator to separate fluorescent light from the emitted particle light converted into the collimated light by the collimating lens; and
a light receiver to receive the fluorescent light separated by the light separator.

17. The microorganism detection apparatus according to claim 15, wherein the opening is provided at one side of the mirror chamber so that a first focal point and a second focal point are located in the oval longitudinal section of the mirror chamber.

18. The microorganism detection apparatus according to claim 17, wherein the mirror chamber is configured so that light is emitted from the particles at the first focal point.

19. The microorganism detection apparatus according to claim 18, wherein the opening is provided at a side of the mirror chamber adjacent to the second focal point.

20. The microorganism detection apparatus according to claim 18, wherein the opening is provided at a side of the mirror chamber adjacent to the first focal point.

21. The microorganism detection apparatus according to claim 15, wherein the light source unit comprises:
a light emitting optical element; and
a converging optical system to converge light emitted from the optical element.

22. The microorganism detection apparatus according to claim 21, wherein the optical element comprises a laser diode or a light emitting diode.

23. The microorganism detection apparatus according to claim 17, wherein eccentricity of the oval longitudinal section of the mirror chamber is adjusted, and a position of the opening is adjusted based on the adjusted eccentricity, to increase condensing efficiency of the condensing optical system.

24. The microorganism detection apparatus according to claim 23, wherein the position of the opening is adjusted so that an angle between one of the first and second focal points, and the opening is equal to a numerical aperture of the condensing optical system.

25. A microorganism detection apparatus comprising:
a mirror chamber having an oval longitudinal section, the mirror chamber being provided with an opening;
an introduction unit through which particles are introduced into the mirror chamber; and
a light source unit to irradiate the particles introduced into the mirror chamber so that light is emitted from the particles, wherein
the opening is provided at one side of the mirror chamber so that a first focal point and a second focal point are located in the oval longitudinal section of the mirror chamber, and the mirror chamber reflects the light emitted from the particles and discharges the reflected light to the opening.

26. The microorganism detection apparatus according to claim 25, wherein the mirror chamber is configured so that light is emitted from the particles at the first focal point.

27. The microorganism detection apparatus according to claim 26, wherein the opening is provided at a side of the mirror chamber adjacent to the second focal point.

28. The microorganism detection apparatus according to claim 26, wherein the opening is provided at a side of the mirror chamber adjacent to the first focal point.

29. A microorganism detection apparatus comprising:
a mirror chamber having an oval longitudinal section, the mirror chamber being provided with an opening;
an introduction unit through which particles are introduced into the mirror chamber; and
a light source unit to irradiate the particles introduced into the mirror chamber so that light is emitted from the particles, wherein
the opening is provided at one side of the mirror chamber so that a first focal point and a second focal point are located in the oval longitudinal section of the mirror chamber, and the mirror chamber reflects the light emitted from the particles and discharges the reflected light to the opening; and
a condensing optical system disposed at an outside of the opening to condense the light discharged out of the mirror chamber through the opening.

30. The microorganism detection apparatus according to claim 29, wherein the condensing optical system comprises:
a collimating lens to convert the light discharged through the opening into collimated light;
a light separator to separate fluorescent light from the light collimated by the collimating lens; and
a light receiver to receive the fluorescent light separated by the light separator.

31. The microorganism detection apparatus according to claim 29, wherein eccentricity of the oval longitudinal section of the mirror chamber is adjusted and a position of the opening is adjusted based on the adjusted eccentricity to increase condensing efficiency of the condensing optical system.

32. The microorganism detection apparatus according to claim 31, wherein the position of the opening is adjusted so that an angle between one of the first and second focal points, and the opening is equal to a numerical aperture of the condensing optical system.

33. The microorganism detection apparatus according to claim 25, wherein the particles are environmental air or liquid particles.

34. The microorganism detection apparatus of claim 2, wherein the light receiver comprises a photo diode or a photo multiplier tube.

35. The microorganism detection apparatus of claim 25, further comprising a home appliance receiving the microorganism detection apparatus.

36. The microorganism detection apparatus of claim 2, where the collimating lens comprises hologram optical elements.
